(19) United States
(12) Patent Application Publication
(10) Pub. No.: US 2015/0244717 A1
(43) Pub. Date: Aug. 27, 2015

(54) TRUSTED VIRTUAL COMPUTING SYSTEM

(71) Applicant: Hua Zhong University of Science Technology, Wuhan, Hubei (CN)

(72) Inventors: Hai Jin, Wuhan (CN); Deqing Zou, Wuhan (CN); Weiqi Dai, Wuhan (CN); Changqing Jiang, Wuhan (CN)

(21) Appl. No.: 14/422,823

(22) PCT Filed: Jul. 9, 2013
(86) PCT No.: PCT/CN2013/079037

§ 371 Date: Feb. 20, 2015

(51) Int. Cl. H04L 29/06

(52) U.S. Cl. CPC H04L 63/0853

(57) ABSTRACT

In a computing environment that includes multiple virtual machines performing computing tasks for a same entity, the integrity of each of the virtual machines may be synchronized between different virtual machines to create a trusted logic virtual domain for a user.

### TECHNICAL FIELD

The technologies described herein pertain generally to trusted virtual computing systems that provide multiple trusted logic virtual domains in a cloud computing environment.

### BACKGROUND

Unless otherwise indicated herein, the approaches described in this section are not prior art to the claims in this application and are not admitted to be prior art by inclusion in this section.

In a cloud computing system, a single tenant's applications may be deployed on multiple virtual machines as a logic virtual domain. To ensure the security of the logic virtual domain, typically, the cloud computing system may be configured to construct a holistic trusted environment, e.g., Trusted Logic Virtual Domain, on a single computing device.

### SUMMARY

Technologies are generally described for a trusted virtual computing system. The various techniques described herein may be implemented in various devices, methods and/or systems.

In some examples, various embodiments may be implemented as devices. Some devices may include one or more hardware components; a hypervisor configured to execute on at least one of the hardware components; and a privileged domain comprising a security module configured to authorize access to the hypervisor, and to manage one or more virtual machines that are grouped with one or more additional virtual machines disposed on other network nodes to form one or more respective trusted logic virtual domains based on one or more predetermined criteria, one or more trusted platform modules (TPMs), each of which corresponds to each of the one or more respective trusted logic virtual domains, each of which is configured to generate a system security state for each of the respective one or more trusted logic virtual domains, and a synchronization module configured to synchronize the system security state between at least one of the one or more virtual machines and the one or more additional virtual machines in a same one of the one or more trusted logic virtual domains.

In some examples, various embodiments may be implemented as methods. Some methods may include managing one or more virtual machines on a physical node, forming a trusted logic virtual domain by grouping each of the one or more virtual machines with one or more other virtual machines on other physical nodes, generating a system security state, e.g., dangerous, safe, attacked, etc., for each of the trusted logic virtual domain, identifying one or more events that change the system security state of one of the one or more virtual machines in the trusted logic virtual domain, changing the system security state of one of the one or more virtual machines in the trusted logic virtual domain, and synchronizing the system security states of other virtual machines in the trusted logic virtual domain.

In some examples, various embodiments may be implemented as computer-readable mediums having executable instructions stored thereon. Some computer-readable mediums may store instructions that, when executed, cause one or more processors to perform operations comprising activating a privileged domain to manage one or more virtual machines, each of which is grouped with other virtual machines on at least one physical nodes to form a trusted logic virtual domain that is assigned a system security state; allocating a portion of physical memory to each of the one or more virtual machines to store the system security state; transmitting the system security state of one of the one or more trusted logic virtual domains to a corresponding trusted platform module in the privileged domain; and authorizing a synchronization module in the privileged domain to update the system security state to other virtual machines hosted on the plurality of physical nodes.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items. In the drawings:

FIG. 1 shows an example system in which a trusted virtual computing system may be implemented;

FIG. 2 shows an example physical node by which a trusted virtual computing system may be implemented;

FIG. 3 shows an example configuration of a processing flow of operations by which a trusted virtual computing system may be implemented;

FIG. 4 shows an example configuration of a sub-processing flow of operations by which a trusted virtual computing system may be implemented; and

FIG. 5 shows a block diagram illustrating an example computing device that is arranged for trusted virtual computing system,

all arranged in accordance with at least some embodiments described herein.

### DETAILED DESCRIPTION

In the following detailed description, references are made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

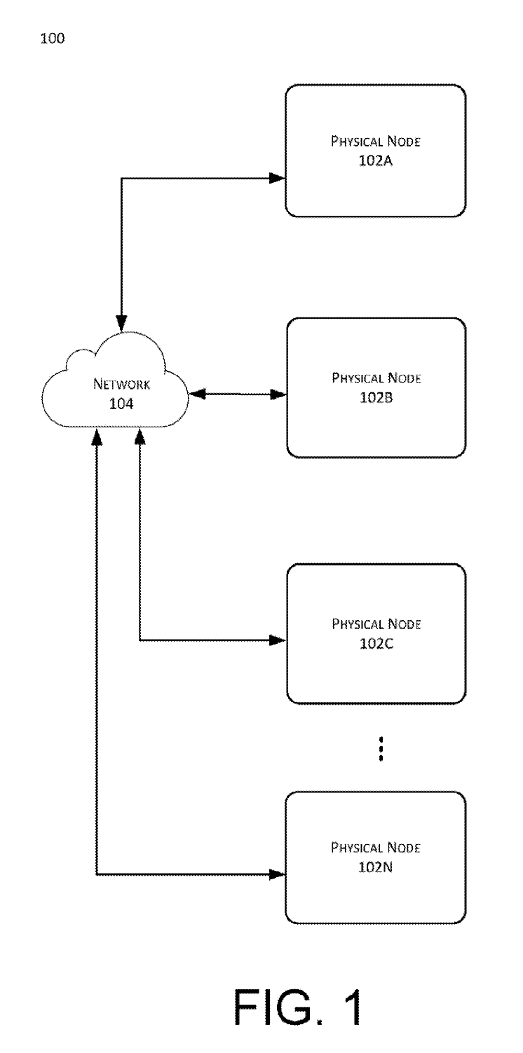

FIG. 1 shows an example system 100 in which a trusted virtual computing system may be implemented, arranged in accordance with at least some embodiments described herein. As depicted, example system 100 may include, at least, one or more physical nodes 102A-102N, and a network 104 to which one or more of physical nodes 102A-102N are communicatively coupled. Unless context requires specific reference to one or more of physical nodes 102A-102N, collective reference may be made to “physical nodes 102” below.

Physical nodes 102 may refer to one or more computing devices that may be communicatively coupled to each other via network 104. Physical nodes 102 may each include one or more hardware components, e.g., memories, central processing units (CPUs), network adapters, etc., to perform computing tasks in accordance with one or more requests from at least one of multiple clients. Each of physical nodes 102 may be configured to host one or more virtual machines that are software implementations of physical computing devices. Each of the one or more virtual machines may be configured to perform computing tasks from at least one of the multiple clients. In some examples, the computing tasks in accordance with the one or more requests from at least one of the multiple clients may be performed by one or more virtual machines on one or more of physical nodes 102. The one or more virtual machines performing the aforementioned computing tasks may be referenced as a trusted logic virtual domain (TLVD) when the one or more requests are received from one client, from multiple clients corresponding to a common organization or entity, or from multiple clients from a common geographical location. For example, virtual machines corresponding to client devices of a particular company or entity may be grouped as a TLVD; or, virtual machines corresponding to client devices located within a common office building or complex may be grouped as another TLVD. For data security purposes, when one or more virtual machines on a physical node are attacked, i.e., subjected to unauthorized attempts to access, other virtual machines in the same TLVD may be so notified and, accordingly, cease to transfer confidential information to any of the attacked virtual machines and/or cease to receive data from the attacked virtual machine. That is, the security state of the TLVD may be synchronized among the virtual machines corresponding to a common TLVD.

In accordance with some examples, one or more of the multiple clients may request verification of the integrity of a respective TLVD, which may be indicated by the security state, before submitting confidential computing tasks to the TLVD. Corresponding one of physical nodes 102 may be configured to sign a packet that includes a random number received from the requesting clients and a hash value of the security state.

As referenced herein, signing may refer to encrypting a target data with a predetermined secret key, i.e., a piece of information that determines the functional output of a cryptographic algorithm.

As reference herein, “hash value” may refer to the output of a hash function of input that may include the system security state of a corresponding TPM. A hash function may refer to any algorithm that maps large data sets of variable length to smaller data sets of a fixed length.

The signed packet may be returned to the respective requesting clients, which may then verify the packet with a public key to ensure the system security state meets the requirement to submit further computing tasks, which may include confidential information, to the respective TLVD. As referenced herein, public key may refer to a piece of information that decrypts the encrypted data.

Network 104 may refer to one or more communication links that follow at least one of communication protocols to support communication between physical nodes 102. The communication protocols may include any mobile communications technology, e.g., GSM, CDMA, etc., depending upon the technologies supported by particular wireless service providers. The one or more communication links may be implemented utilizing non-cellular technologies such as conventional analog AM or FM radio, Wi-Fi™, wireless local area network (WLAN or IEEE 802.11), WiMAX™ (Worldwide Interoperability for Microwave Access), Bluetooth™, hard-wired connections, e.g., cable, phone lines, and other analog and digital wireless voice and data transmission technologies.

Thus, FIG. 1 shows an example system 100 at least includes physical nodes 102 communicatively coupled to each other via network 104.

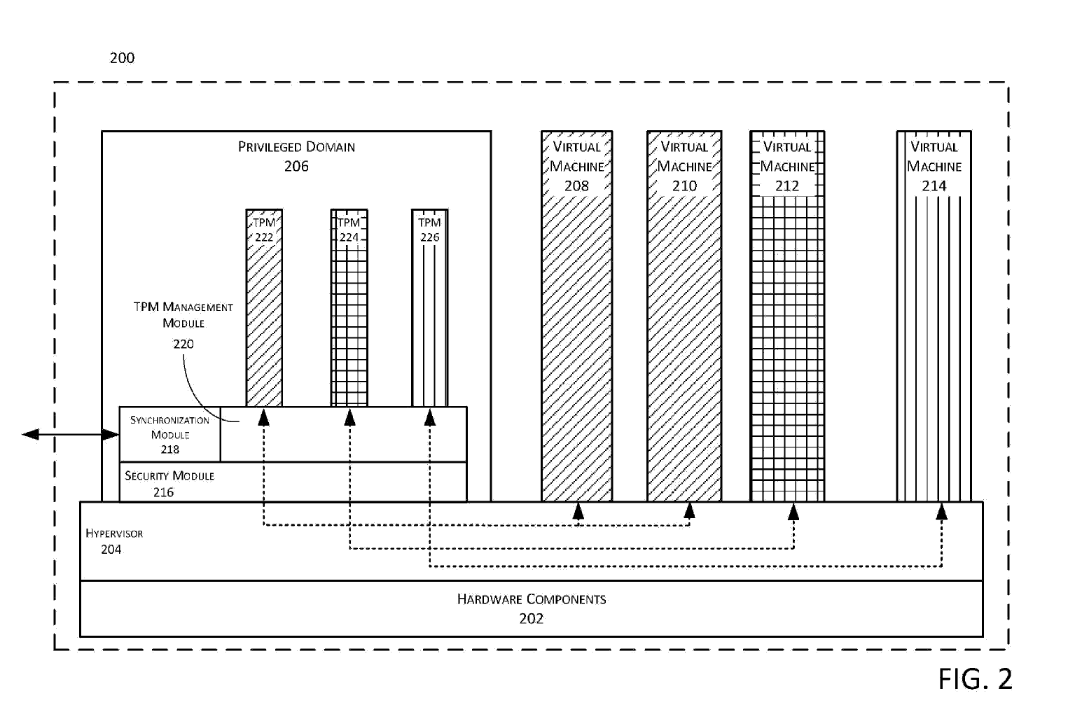

FIG. 2 shows an example physical node 102 by which a trusted virtual computing system may be implemented, arranged in accordance with at least some embodiments described herein. As depicted, example physical node 102 may include, at least, one or more hardware components 202; a hypervisor 204 executing on hardware components 202; and a privileged domain 206 configured to manage one or more virtual machines 208, 210, 212, and 214. Privileged domain 206 may include, at least, a security module 216, a synchronization module 218, a trusted platform module (TPM) management module 220, and one or more TPMs 222, 224, and 226.

Hardware components 202 may refer to one or more physical elements that constitute a computer system, e.g., physical nodes 102. Non-limiting examples of hardware components 202 may include one or more memories, one or more CPUs, one or more network adapters, one or more graphic processing units (GPUs), one or more motherboards, etc.

Hypervisor 204 may refer to a software module that may be configured to execute directly on hardware component 202 to receive one or more requests for computing tasks from other software modules, i.e., clients, including virtual machines 208, 210, 212, and 214; and to manage access to hardware components 202 in response to independent requests from different software modules. In some example embodiments of a trusted virtual computing system, hypervisor 204 may be the only component, from among other software components executed on physical node 102, which has direct access to any of hardware components 202. Typically, by separating virtual machines 208, 210, 212, and 214 from hardware components 202, hypervisor 204 may be able to execute multiple operating systems securely and independently on each of virtual machines 208, 210, 212, and 214.

Privileged domain 206 may refer to a software component, initiated by hypervisor 204 that may be configured to manage virtual machines 208, 210, 212, and 214. Thus, privileged domain 206 may further be configured to possess multiple privileges to access hypervisor 204. The privileges may allow privileged domain 206 to manage different aspects of virtual machines 208, 210, 212, and 214 such as starting, interrupting, stopping, inputting/outputting requests, etc.

Privileged domain 206 may further include security module 216, synchronization module 218; TPM management module 220; and TPMs 222, 224, and 226.

Virtual machines 208, 210, 212, and 214 may refer to one or more software emulations of physical computing devices, which may be configured to execute software programs as real physical computing devices. Virtual machines 208, 210, 212, and 214 may be initiated and managed by privileged domain 206. In some examples, one or more of virtual machines 208, 210, 212, and 214 may be configured to execute an independent operating system that is different from operating systems that are executing on other ones of virtual machines 208, 210, 212, and 214. In other examples, one or more of virtual machines 208, 210, 212, and 214 may be configured to execute a single software program, portions of a single software program, or a single process. In accordance with some example embodiments, the execution of an application may be separated into different portions and, further, distributed to one or more of virtual machines 208, 210, 212, and 214 over different ones of physical nodes 102. Further, although physical node 102 includes virtual machines 208, 210, 212, and 214, such depiction is provided as a non-limiting example that is not so restricted with regard to quantity.

As set forth above, privileged domain 206 may further include security module 216; synchronization module 218; and TPM management module 220, TPMs 222, 224, and 226.

Security module 216 may refer to a software component that may be configured to authorize access to hypervisor 204 and to manage virtual machines 208, 210, 212, and 214. Further, security module 216 may be configured to group the different virtual machines, over different ones of physical nodes, as a TLVD. Security module 216 may group the different virtual machines to perform computing tasks from a same client, multiple clients corresponding to a common organization, or multiple clients located at a common geographical location.

As depicted in the non-limiting example embodiment of FIG. 2, virtual machines 208 and 210 may be grouped together as one TLVD, and virtual machines 212 and 214 may be respectively grouped with other virtual machines corresponding to different embodiments of physical node 200 as part of other TLVDs. As set forth above, a virtual machine may transmit and receive data to and from other virtual machines within a common TLVD. Thus, in accordance with some example embodiments, when one virtual machine is attacked or hacked, other virtual machines corresponding to the same TLVD may be notified and may therefore stop communicate with the attacked virtual machine to ensure data security.

TPMs 222, 224, and 226 may each refer to a software component of privileged domain 206. Each of TPMs 222, 224, and 226 may be configured to generate a system security state for each of the multiple TLVDs represented by the virtual machines corresponding to the same physical node 102. The system security state may indicate the integrity of a respective TLVD, i.e., whether the virtual machines in the respective TLVD are secure from external attacks and therefore able to securely communicate with other virtual machines in the same TLVD. The system security state may further indicate, for each of the multiple TLVDs represented by the virtual machines corresponding to the same physical node 102, respective security levels, e.g., “dangerous,” “safe,” “unknown attack,” etc. In accordance with some examples, a mirror copy of the system security state, which represents the integrity of a TLVD, may be stored in a corresponding one of TPMs 222, 224, and 226. That is, at each one of physical nodes 102, hypervisor 204 may be configured to allocate a portion of memory of hardware component 202 to the corresponding one of TPMs 222, 224, and 226 to store the mirror copy of the system security state. Further, although privileged domain 206 includes TPMs 222, 224, and 226, such depiction is provided as a non-limiting example that is not so restricted with regard to quantity.

Virtual machines in the respective TLVD and other components, e.g., hypervisor 204, may perform differently according to the system security state. For example, hypervisor 204 may deny the requests to transmit confidential information from one virtual machine to another within the same TLVD when the system security state is set as “unknown attack.” In other examples, hypervisor 204 may deny all requests from any virtual machine of a TLVD if the system security state of the TLVD is set as “dangerous.”

TPM management module 220 may refer to a software component that may be configured to receive relevant security information from virtual machines 208, 210, 212, and 214 and further to update the system security state generated by TPMs 222, 224, and 226. Communication between TPMs 222, 224, and 226 and respective ones of virtual machines 208, 210, 212, and 214 may be implemented by sharing portions of one or more physical memories that are included in hardware components 202, as designated by hypervisor 204. That is, hypervisor 204 may allocate a portion of one or more physical memories included in hardware components 202 for a respective one of TPMs 222, 224, and 226 and any one of corresponding virtual machines 208, 210, 212, and 214, both of which may access the allocated portion of the one or more physical memories so that security information are not transmitted via network adapters, resulting in a reduction of any latency in transmission. The security information may refer to a record of events that may affect the system security state such as the frequency for a virtual machine being attacked in a given time period.

In accordance with some examples, commands from one or more of virtual machines 208, 210, 212, and 214 to access a respective one of TPMs 222, 224, and 226 may alter the system security state stored in the respective TPM. In some examples, the commands may include retrieving or storing one or more secret keys from or in the TPM. As referenced herein, a secret key may refer to one or more pieces of information that may determine a functional output of a cryptographic algorithm. The respective TPM may be configured to execute one of the commands and synchronize the system security state with the TPMs corresponding to other embodiments of physical node 102 via synchronization module 218. Further, the integrity of the mirror copy of the system security state may be verified before the execution of the commands and the system security state may be altered in response to the commands. That is, the result of execution of the commands may be temporarily stored in RAM corresponding to hardware components 202. When the command does not alter the system security state, e.g., authorized access to hardware components 202, the respective TPM may return the temporarily stored execution result to the one or more of virtual machines 208, 210, 212, and 214 that submitted the command. Alternatively, when the command alters the system security state, synchronization module 218 may be configured to synchronize the system security state between different embodiments of physical node 102 of the corresponding TLVD, as described below, and the TPM may re-execute the command in accordance with the altered system security state and return the result of re-execution.

Synchronization module 218 may refer to a software component that may be configured to synchronize the system security state of the respective TLVDs among one or more TPMs on different physical nodes. As described above, portions of computing tasks from a single client may be distributed over a plurality of virtual machines on different physical nodes. The plurality of virtual machines may form a TLVD and communicate with each other to perform the computing tasks. In accordance with some examples, when one or more of virtual machines 208, 210, 212, and 214 on physical node 102 is detected to be under attack and the system security state is updated to be “dangerous” by TPM management module 220, synchronization module 218 may be configured to then notify virtual machines on other embodiments of physical node 102, by submitting the updated system security state, which indicates that transceiving data relative to the one or more virtual machines under attack is not allowed. That is, the stored mirror copy of the system security state on other embodiments of physical node 102 may be modified to reflect the changed integrity of the corresponding TLVD. Thus, all virtual machines within a same TLVD may share a same system security state that may be updated by synchronization module 218.

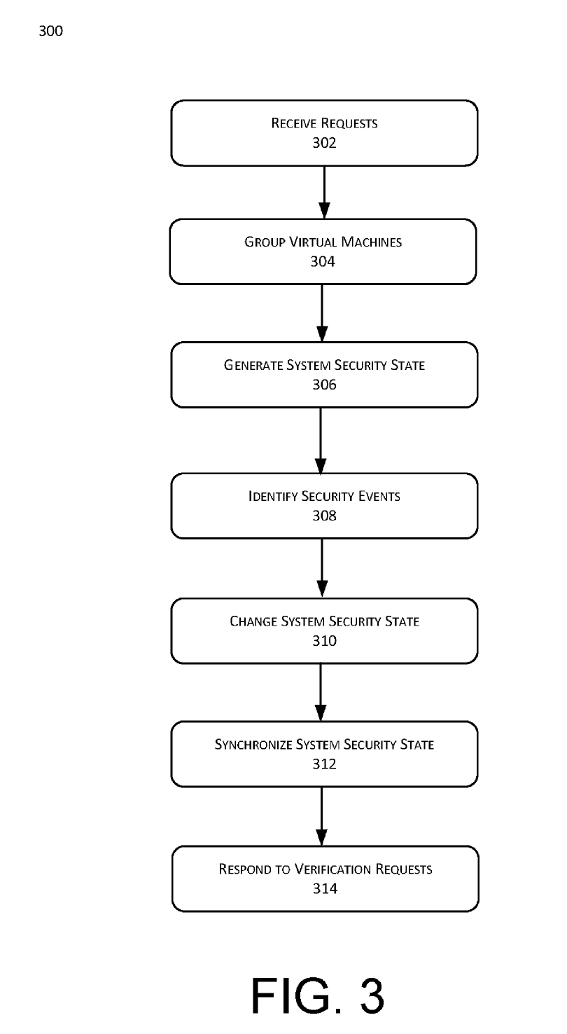

FIG. 3 shows an example configuration of a processing flow 300 of operations by which a trusted virtual computing system may be implemented, arranged in accordance with at least some embodiments described herein. As depicted, processing flow 300 may include sub-processes executed by various components that are part of example system 100. However, processing flow 300 is not limited to such components, and modification may be made by re-ordering two or more of the sub-processes described here, eliminating at least one of the sub-processes, adding further sub-processes, substituting components, or even having various components assuming sub-processing roles accorded to other components in the following description. Processing flow 300 may include various operations, functions, or actions as illustrated by one or more of blocks 302, 304, 306, 308, 310, 312, and/or 314. Processing may begin at block 302.

Block 302 (Receive Requests) may refer to receiving one or more requests to access hypervisor 204 from one or more of virtual machines 208, 210, 212, and 214. As set forth above, security module 216 may be configured to manage operation of virtual machines 208, 210, 212, and 214, including launching and/or stopping operations of one or more of the virtual machines. Virtual machines 208, 210, 212, and 214 may not have direct access to hypervisor 204 and hardware components 202, and therefore security module 216 may be configured to access hypervisor 204 on behalf of one or more of virtual machines 208, 210, 212, and 214. Processing may continue from block 302 to block 304.

Block 304 (Group Virtual Machines) may refer to security module 216 grouping one or more of virtual machines 208, 210, 212, and 214, and possibly one or more virtual machines that are disposed on other network nodes to form a respective TLVD, based on one or more predetermined criteria. For example, virtual machines may be grouped together, regardless of whether they are disposed on a common network node, to form a TLVD when the virtual machines perform computing tasks in response to one or more requests from a common client, from multiple clients of a common organization or entity, or from multiple clients at a same geographical location. Processing may continue from block 304 to block 306.

Block 306 (Generate System Security State) may refer to one or more of TPMs 222, 224, and 226 generating a system security state for each of the respective one of the one or more TLVDs formed by security module 216. The system security state may indicate the integrity of a TLVD, i.e., whether the virtual machines in the TLVD are secured against external attacks to communicate with other virtual machines in the TLVD. The system security state may include a number of security levels, e.g., “dangerous,” “safe,” “unknown attack,” etc. Processing may continue from block 306 to block 308.

Block 308 (Identify Security Events) may refer to one or more of TPMs 222, 224, and 226 identifying one or more events that may affect the integrity of a respective TLVD and further cause potential risks to data safety. Such events may include cyber-attacks, security breaches, unauthorized attempts to access confidential information, etc. Processing may continue from block 308 to block 310.

Block 310 (Change System Security State) may refer to one or more of TPMs 222, 224, and 226 changing the system security state of a respective TLVD in response to the identified security events. For example, one or more of TPMs 222, 224, and 226 may be configured to change the system security state from a “safe” state to a “dangerous” state in response to an authorized attempt to access confidential information from one of the virtual machines of the respective TLVD. In response to different system security states, virtual machines in the respective TLVD and other components, e.g., hypervisor 204, may perform differently. For example, hypervisor 204 may deny a request to transmit confidential information from one virtual machine to another within the same TLVD when the system security state indicates an “unknown attack.” In other examples, hypervisor 204 may deny all requests from any virtual machine of a respective TLVD if the system security state of the TLVD indicates a “dangerous” state. Processing may continue from block 310 to block 312.

Block 312 (Synchronize System Security State) may refer to synchronization module 218 synchronizing the system security state between at least one of virtual machines 208, 210, 212, and 214 and the one or more virtual machines in a same respective TLVD that may be disposed on another network node. In accordance with some example embodiments, the system security state may be updated to indicate a “dangerous” state by TPM management module 220 when one or more virtual machines on physical node 102 are under attack. Synchronization module 218 may be configured to then notify virtual machines on other embodiments of physical node 102, by submitting the updated system security state which indicates that transceiving data relative to the one or more virtual machines under attack is not allowed. Thus, all virtual machines within a same TLVD may share a same system security state that may be updated by synchronization module 218. Processing may continue from block 312 to block 314.

Block 314 (Respond to Verification Requests) may refer to one or more of TPMs 222, 224, and 226 responding to one or more verification requests, from one or more requesting clients, to verify the system security state of a respective TLVD. The one or more requesting clients may refer to one or more potential future clients that need to verify the integrity of the system before submitting confidential computing tasks to the TLVD.

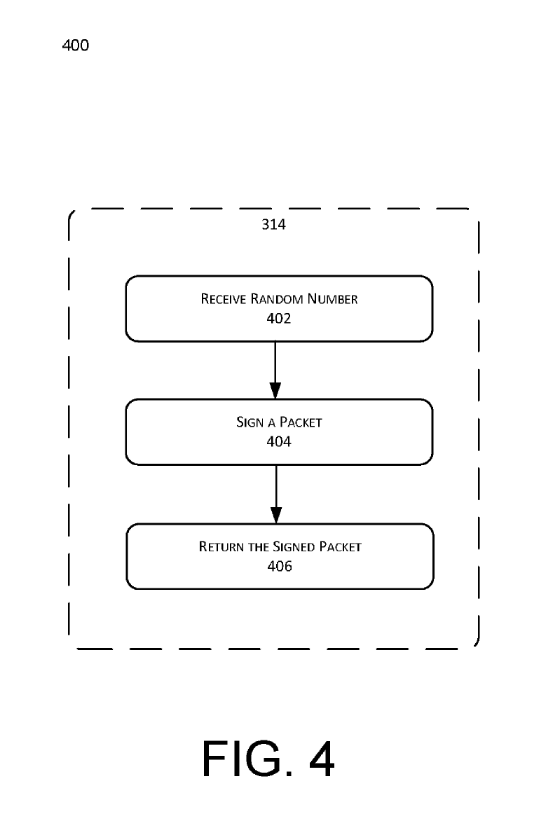

FIG. 4 shows an example configuration of a sub-processing flow 400 of operations by which a trusted virtual computing system may be implemented, arranged in accordance with at least some embodiments described herein. As depicted, processing flow 400 may include sub-processes executed by various components that are part of example system 100. However, processing flow 400 is not limited to such components, and modification may be made by re-ordering two or more of the sub-processes described here, eliminating at least one of the sub-processes, adding further sub-processes, substituting components, or even having various components assuming sub-processing roles accorded to other components in the following description. Processing flow 400 may include various operation, functions, or actions as illustrated by one or more of blocks 402, 404, and/or 406. Processing may begin at block 402.

Block 402 (Receive Random Number) may refer to one or more of TPMs 222, 224, and 226 receiving a random number in one of the one or more verification requests. The random number may be generated by the one or more requesting clients. Processing may continue from block 402 to block 404.

Block 404 (Sign a Packet) may refer to one or more of TPMs 222, 224, and 226 signing, with a secret key corresponding to the respective TPM, a packet that may include the received random number and a hash value of the respective system security state.

Block 406 (Return the Signed Packet) may refer to one or more of TPMs 222, 224, and 226 returning the signed packet to the one or more requestors. The one or more requestors may then verify the packet with a public key to ensure the system security state meets the requirement to submit further computing tasks to the respective TLVD.

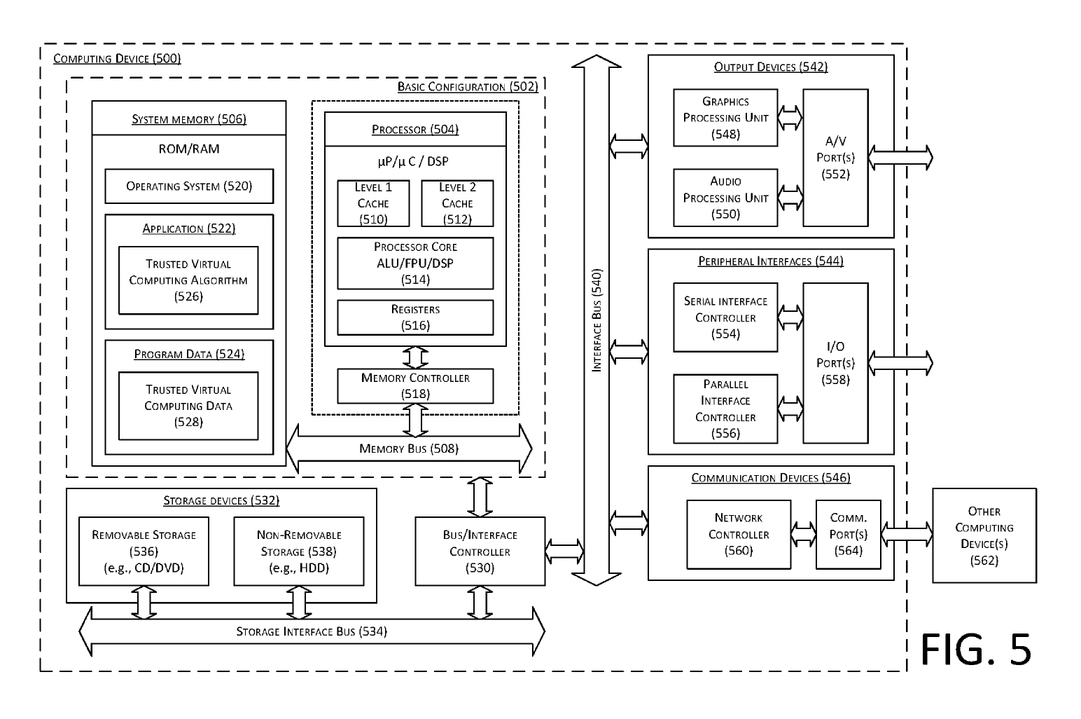

FIG. 5 shows a block diagram illustrating an example computing device that is arranged for trusted virtual computing system, arranged in accordance with at least some embodiments described herein.

In a very basic configuration 502, computing device 500 typically includes one or more processors 504 and a system memory 506. A memory bus 508 may be used for communicating between processor 504 and system memory 506.

Depending on the desired configuration, processor 504 may be of any type including but not limited to a microprocessor (μP), a microcontroller (μC), a digital signal processor (DSP), or any combination thereof. Processor 504 may include one more levels of caching, such as a level one cache 510 and a level two cache 512, a processor core 514, and registers 516. An example processor core 514 may include an arithmetic logic unit (ALU), a floating point unit (FPU), a digital signal processing core (DSP Core), or any combination thereof. An example memory controller 518 may also be used with processor 504, or in some implementations memory controller 518 may be an internal part of processor 504.

Depending on the desired configuration, system memory 506 may be of any type including but not limited to volatile memory (such as RAM), non-volatile memory (such as ROM, flash memory, etc.) or any combination thereof. System memory 506 may include an operating system 520, one or more applications 522, and program data 524. Application 522 may include a trusted virtual computing algorithm 526 that is arranged to perform the functions as described herein including those described with respect to process 300 of FIG. 3 and sub-process 400 of FIG. 4. Program data 524 may include trusted virtual computing data 528 that may be useful for operation with trusted virtual computing algorithm 526 as described herein. Trusted virtual computing data 528 may include the system security state, one or more private keys, and/or one or more public keys. In some embodiments, application 522 may be arranged to operate with program data 524 on operating system 520 such that implementations of trusted virtual computing system may be provided as describe herein. This described basic configuration 502 is illustrated in FIG. 5 by those components within the inner dashed line.

Computing device 500 may have additional features or functionality, and additional interfaces to facilitate communications between basic configuration 502 and any required devices and interfaces. For example, a bus/interface controller 530 may be used to facilitate communications between basic configuration 502 and one or more data storage devices 532 via a storage interface bus 534. Data storage devices 532 may be removable storage devices 536, non-removable storage devices 538, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 506, removable storage devices 536 and non-removable storage devices 538 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 500. Any such computer storage media may be part of computing device 500.

Computing device 500 may also include an interface bus 540 for facilitating communication from various interface devices (e.g., output devices 542, peripheral interfaces 544, and communication devices 546) to basic configuration 502 via bus/interface controller 530. Example output devices 542 include a graphics processing unit 548 and an audio processing unit 550, which may be configured to communicate to various external devices such as a display or speakers via one or more A/V ports 552. Example peripheral interfaces 544 include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 546 includes a network controller 560, which may be arranged to facilitate communications with one or more other computing devices 562 over a network communication link via one or more communication ports 564.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 500 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 500 may also be implemented as a personal computer including both laptop computer and non-laptop computer configurations.

In an illustrative embodiment, any of the operations, processes, etc. described herein can be implemented as computer-readable instructions stored on a computer-readable medium. The computer-readable instructions can be executed by a processor of a mobile unit, a network element, and/or any other computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an”(e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A trusted computing system, comprising:
one or more hardware components;
a hypervisor configured to execute on at least one of the hardware components; and
a privileged domain comprising:
a security module configured to:
authorize access to the hypervisor, and
manage one or more virtual machines that are grouped with one or more additional virtual machines disposed on other network nodes to form one or more respective trusted logic virtual domains based on one or more predetermined criteria, one or more trusted platform modules (TPMs), each of which corresponds to each of the one or more respective trusted logic virtual domains, each of which is configured to generate a system security state for each of the respective one or more trusted logic virtual domains, and
a synchronization module configured to synchronize the system security state between at least one of the one or more virtual machines and the one or more additional virtual machines in a same one of the one or more trusted logic virtual domains.

2. The trusted computing system of claim 1, wherein the system security state includes one or more security levels.

3. The trusted computing system of claim 1, wherein the privileged domain further comprises a TPM management module configured to receive security information from the one or more virtual machines and to update the system security state of each of the one or more virtual machines.

4. The trusted computing system of claim 1,
wherein each of the one or more virtual machines is allocated with a portion of physical memory of the network node to store the system security state; and
wherein the synchronization module is authorized to access the portions of physical memory allocated to each of the one or more virtual machines.

5. The trusted computing system of claim 1, wherein the one or more predetermined criteria at least include identity of a user, organization that the user belongs to, or geographical information.

6. The trusted computing system of claim 1, wherein the one or more TPMs are configured to respond to one or more verification requests to verify the system security state of at least one of the one or more trusted logic virtual domains.

7. (canceled)

8. A method, comprising:
managing one or more virtual machines on a physical node;
forming a trusted logic virtual domain by grouping each of the one or more virtual machines with one or more other virtual machines on other physical nodes;
generating a system security state for each of the trusted logic virtual domain;
identifying one or more events that change the system security state of one of the one or more virtual machines in the trusted logic virtual domain;
changing the system security state of one of the one or more virtual machines in the trusted logic virtual domain; and
synchronizing the system security states of other virtual machines in the trusted logic virtual domain.

9. The method of claim 8, wherein the forming includes grouping each of the one or more virtual machines with one or more other virtual machines on other physical nodes based on one or more predetermined criteria that includes at least one of an identity of a user of one of the virtual machines, an identity of an entity to which the user belongs, or a location of the user or entity.

10. The method of claim 8, wherein the system security state includes one or more security levels.

11. The method of claim 8, wherein the synchronizing includes retrieving the system security state from a portion of physical memory allocated to one or the one or more virtual machines.

12. The method of claim 8, further comprising responding to one or more verification requests, from one or more requestors, to verify the system security state of the trusted logic virtual domain.

13. The method of claim 10, further comprising denying one or more requests to transfer confidential information when the system security state reaches a predetermined one of the one or more security levels.

14. The method of claim 12, wherein the responding comprises:
receiving a random number included in one of the one or more verification requests;
signing, with a secret private key, a packet that includes a hash value of the system security state and the random number; and
returning the packet to one of the one or more requestors.

15. A computer-readable medium that stores executable-instructions that, when executed, cause one or more processors to perform operations comprising:
activating a privileged domain to manage one or more virtual machines, each of which is grouped with other virtual machines on at least one physical nodes to form a trusted logic virtual domain that is assigned a system security state;
allocating a portion of physical memory to each of the one or more virtual machines to store the system security state;
transmitting the system security state of one of the one or more trusted logic virtual domains to a corresponding trusted platform module in the privileged domain; and
authorizing a synchronization module in the privileged domain to update the system security state to other virtual machines hosted on the plurality of physical nodes.

16. The computer-readable medium of claim 15, wherein the one or more trusted logic virtual domains are formed based on one or more predetermined criteria that at least include identity of a user of at least one of the virtual machines, an identity of an entity to which the user belongs, or location information of the user or organization.

17. The computer-readable medium of claim 15, wherein the system security state includes one or more security levels.

18. The computer-readable medium of claim 15, wherein the transmitting includes retrieving the system security state from the portion of physical memory and writing the system security state to another portion of physical memory that is accessible to the corresponding trusted platform module.

19. The computer-readable medium of claim 15, wherein the operations further comprise allowing the privileged domain to respond to one or more verification requests, from one or more requestors, by verifying the system security state of at least one of the one or more trusted logic virtual domains.

20. The computer-readable medium of claim 17, wherein the operations further comprise denying one or more requests to transfer confidential information when the system security state reaches a predetermined one of the one or more security levels.

21. The computer-readable medium of claim 17, further comprising denying one or more requests to access one or more hardware components when the system security level reaches the predetermined one of the one or more security levels.
